(19) United States
(12) Patent Application Publication
(10) Pub. No.: US 2014/0075350 A1
(43) Pub. Date: Mar. 13, 2014

(54) VISUALIZATION AND INTEGRATION WITH ANALYTICS OF BUSINESS OBJECTS

(71) Applicants: Alain Gauthier, Montreal (CA); Xuebo Liang, Brossard (CA); Rolan Abdukalykov, Montreal (CA); Roy Ghorayeb, Montreal (CA); Vincent Lavoie, Montreal (CA); Mohannad El-Jayousi, L'lle-Bizard (CA)

(72) Inventors: Alain Gauthier, Montreal (CA); Xuebo Liang, Brossard (CA); Rolan Abdukalykov, Montreal (CA); Roy Ghorayeb, Montreal (CA); Vincent Lavoie, Montreal (CA); Mohannad El-Jayousi, L'lle-Bizard (CA)

(73) Assignee: SAP AG, Walldorf (DE)

(21) Appl. No.: 13/608,823

(22) Filed: Sep. 10, 2012

(51) Int. Cl. G06F 3/048

(52) U.S. Cl. 715/765

(57) ABSTRACT

A system and method are described herein that provide for visualizing business objects stored in a backend system for display in a user interface. Business objects are retrieved from the backend system. Metadata from the business objects are customized and sorted into a plurality of categories. The business objects are changed into a necessary data format for transmittal and transmitted to the application displayed on the user interface. During runtime, custom actions pertaining to each business object are dynamically rendered and assigned based on the backend customization of the metadata. Custom actions include the creation or updating of entries in the application.

### BACKGROUND INFORMATION

Business software such as enterprise resource planning software implements business processes by modeling business data as business objects with data exchange between the objects. The business data provided via the business objects can be accessed through mechanisms such as graphical user interfaces, forms, and analytical reports. Traditionally, user interfaces providing access to business objects conveyed limited information about the attributes associated with the business objects. User interface that provide a calendar interface have presently been limited in their implementation.

Current mobile applications do not provide the functionality to fetch business objects from a backend system along with analytic integration of each business object and integrate into a calendar interface of an application. Current applications are also restrictive, in that changes and edits of the business objects and their respective attributes or states can't be made within a real-time view of a calendar interface.

Thus, there remains a need in the art for a system for visualizing business objects stored in a backend system and rendered in a real-time navigable time view. There also remains a need in the art to integrate business objects in a calendar application where the application is customizable to the rendered business objects.

### SUMMARY

A system and method are described herein that provide for visualizing business objects stored in a backend system for display in a user interface. Business objects are retrieved from the backend system. Metadata from the business objects are customized and sorted into a plurality of categories. The business objects are changed into a necessary data format for transmittal and transmitted to the application displayed on the user interface. During runtime, custom actions pertaining to each business object are dynamically rendered based on the backend customization of the metadata. Custom actions include, but are not limited to, the creation or updating of entries in the application, trigger workflow, send email, trigger alerts, etc.

In particular, the exemplary embodiments and/or exemplary methods are directed to a system and method for visualizing business objects stored in a backend system in an application. The system and method include a mobile device that executes an application that retrieves the business objects stored in the backend system and sorts metadata of the business objects into customized categories. The business objects can also be integrated with analytics corresponding to the business objects. Before transmission from the backend system to the application on the mobile device, the business objects can be converted into a necessary data format for transmission by a gateway. After conversion, the business objects are transmitted to the application through a platform, such as a Sybase Platform™.

During rendering time, custom actions to be performed by business entities are dynamically generated based on backend customizing and metadata and bind to the business entity (or object). Visual representations of the business objects can be displayed in a user interface of the mobile device. Analytics of the business objects can also be displayed in the user interface.

In an example embodiment, the application on the mobile device is a calendar application. Upon user interaction with the user interface a custom action may be trigger, this action may lead for example to, but not limited to, a new calendar entry, update, deletion, navigation, search, etc. In this embodiment, the business objects and the business object attribute values can both be edited in real-time within a calendar view of the calendar application. The calendar application can be configured to dynamically adapt to each rendered business object.

### BRIEF DESCRIPTION OF THE DRAWINGS

FIG. 1 is a diagram of system architecture for retrieving the business objects and corresponding analytics from a backend system according to an embodiment.

FIG. 2 is a diagram of an architecture diagram of the related business object metadata categories, retrieved from a backend system according to an embodiment.

FIG. 3 is a diagram of a process for retrieving business objects from a backend server at runtime according to an embodiment.

FIG. 4 is a diagram of representing the result of a custom action, presenting transaction data and metadata together with additional custom actions all dynamically rendered at runtime based on the backend customizing according to an embodiment.

FIG. 5 is a diagram of a graphical user interface that displays business objects dynamically rendered at runtime according to an embodiment.

FIG. 6 is a diagram of the layout of a user interface displaying business objects dynamically rendered at runtime according to an embodiment.

FIG. 7 is a diagram of the user interface displaying business objects alongside detail boxes containing business object information dynamically rendered at runtime according to an embodiment.

### DETAILED DESCRIPTION

The subject matter will now be described in detail for specific preferred embodiments, it being understood that these embodiments are intended only as illustrative examples and is not to be limited thereto these embodiments.

Embodiments may discuss a system and method for retrieving business objects stored in a backend system and integrating into a navigable time view of an application displayed in a user interface. Business objects may be retrieved from the backend system. Metadata from the business objects may be customized and sorted into a plurality of categories. The business objects may be changed into a necessary data format for transmittal and transmitted to the application displayed on the user interface. During runtime, custom actions pertaining to each business object may be dynamically rendered based on the backend customization of the metadata. In an embodiment, the custom action may be triggered upon user interaction with the application and the device. Custom actions may include the creation or update of entries in the application, navigation in time, visualization of analytics, raise an alert, trigger workflow, etc.

Each of the business objects may be provided its own space and position in time so that none of the retrieved business objects overlap in position. The business objects attributes of the retrieved business objects may be edited or changed in real-time in the navigable time view of the application. The retrieved business objects may be integrated with business analytics that are specific to each business object or to all of the business objects displayed in the user interface.

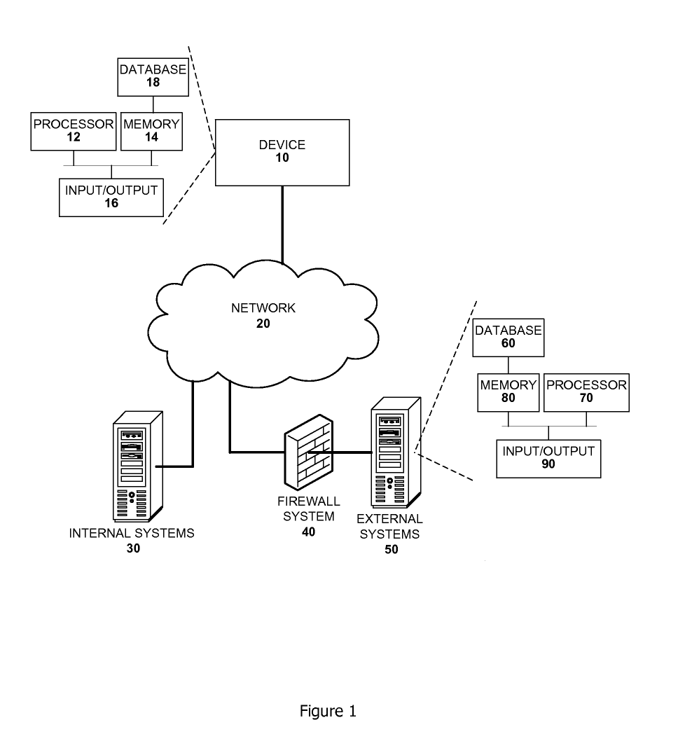

FIG. 1 illustrates an architecture of the system for retrieving the business objects and corresponding analytics from a backend system according to an embodiment. In an embodiment, device 10 may be a hand-held device, personal digital assistant (PDA), television set-top Internet appliance, mobile telephone, smart phone, tablet, Android™ device, iPod™, iPhone™, iPad™, Windows™ based device, etc., or as a combination of one or more thereof, or other comparable device. A mobile application, such as for example, a calendar application, may be executed on device 10. This mobile application may be displayed in user interface that is displayed on a screen of the device 10.

The calendar entries in the application may be updated by connecting device 10 to backend computer systems or networks to retrieve new or updated business objects. The business objects may be stored in one or more database in the backend system. When the business objects are retrieved, the objects may be translated to a data protocol by a gateway that may be part of a firewall system 40. Device 10 may connect to a gateway through a platform that provides a secured connection for connectivity.

The backend systems storing the business objects may be separated into internal backend systems and external backend systems. Device 10 may connect to internal backend systems 30 through a network 20. Device 10 may also connect to external backend systems 50 through the network 20 and a firewall system 40. The firewall system 40 may include a gateway and a platform such as, for example, Sybase™, to translate the business objects to a data protocol and provide a secured connection.

The existing internal backend systems 30 may include a server and may provide business data, including the business objects. The external backend systems 50 may include a server and may be maintained by a third party, such as an information service provider, and may contain business data, including the business objects, that may be updated by the third party on a periodic basis. The application on device 10 may interact with these external systems to obtain updates and new business objects, through a firewall system 40 separating the internal systems from the external systems. The gateway and platform provided by the firewall system 40 allow for a secure transmission of the business objects and other data to device 10. In an embodiment, the functionality provided by the internal backend systems 30 and external backend systems 50 may be provided by the system running the application to retrieve business objects as well as analytics associated with the business objects.

Device 10 may include a processor 12, a memory 14, input/output interface 16, and a database 18. Database 18 may include any type of data storage adapted to searching and retrieval. The database 18 may include any SAP specific database such as HANA™, which may be an in-memory database, or other database system. Memory 14 may have a designated storage capacity that may allow for the storage of the business object attributes and corresponding analytics of the business objects, when a local save function is enable. When a user accesses the locally saved business data, processer 12 may retrieve the data from memory 14. In an embodiment, memory 14 may contain different components for retrieving, presenting, changing, and saving the local data. Memory 14 may include a variety of memory devices, for example, Dynamic Random Access Memory (DRAM), Static RAM (SRAM), flash memory, cache memory, and other memory devices. In an embodiment, memory 14 may be a memory device that may be easily incorporated in a mobile device.

The backend systems 30 and 50 may both contain a processor 70, memory 80, a database 60, and an input/output interface 90, all of which may be interconnected via a system bus. In various embodiments, both of the systems 30 and 50 may have an architecture with modular hardware or software systems that include additional systems communicating through one or more networks. The modular design may enable a business to add, exchange, and upgrade systems, including using systems from different vendors in some embodiments. The architecture may include embodiments that have different configurations than the example embodiment depicted in FIG. 1.

In an embodiment, memory 80 may contain different components for retrieving, presenting, changing, and saving data. Memory 80 may include a variety of memory devices, for example, Dynamic Random Access Memory (DRAM), Static RAM (SRAM), flash memory, cache memory, and other memory devices. Additionally, for example, memory 80 and processor 70 may be distributed across several different computers that collectively comprise a system.

Database 60 may include any type of data storage adapted to searching and retrieval. The database 60 may include any SAP specific database such as HANA, which may be an in-memory database, or other database systems such as Informix, Oracle, DB2, or Sybase™ etc. The databases of internal backend systems 30 and external backend system 50 may store business objects for retrieval by the application executed on device 10.

Processor 70 may perform computation and control functions of a system and comprises a suitable central processing unit. Processor 70 may comprise a single integrated circuit, such as a microprocessor, or may comprise any suitable number of integrated circuit devices or circuit boards working in cooperation to accomplish the functions of a processor. Processor 70 may execute computer programs, such as object-oriented computer programs, within memory 80.

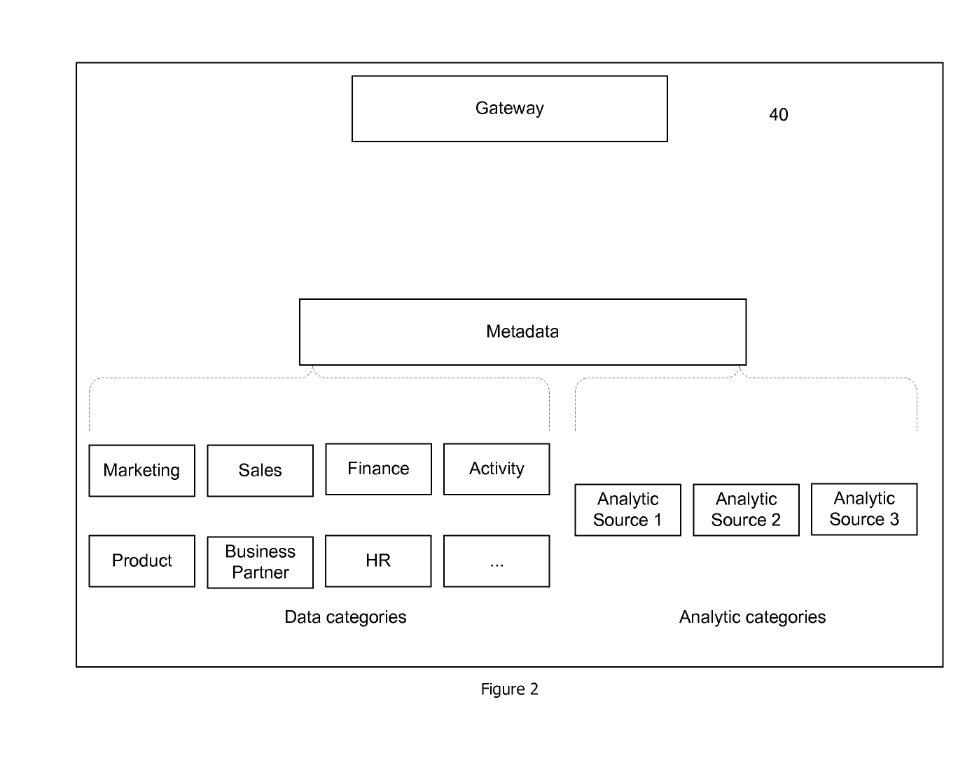

The business objects for the calendar entries may be retrieved from the databases 60 of the internal backend systems 30 and the external backend systems 50 and rendered based on predefined metadata to enable the calendar application to represent different business contexts. FIG. 2 illustrates an architecture of the data structure that can be categorized into a set of metadata. Device 10 may connect through a network 20 to an internal backend system 30 or an external backend system 50, through, for example a Sybase Unwired Platform™ in a firewall system 40. The platform may provide administrative functions such as providing security keys that may enable the connection to external back end system 50 through a business gateway.

The business objects may represent a modeling of a particular business process of the enterprise resource planning software system. Metadata of any business objects may be stored on a database in internal backend system 30 or external backend system 50. In an embodiment where there is an internal backend system, the business objects corresponding to the business processes may also be stored in a database of the internal backend system 30 in addition to the external backend system 50. In an alternate embodiment, there may be no internal backend system, and the system may only include a single backend system, external backend system 50. In this embodiment, the business objects corresponding to the business processes may be stored in a database of the external backend system 50. When business objects are retrieved from database 60 of the external backend system 50, a gateway may transform the internal data protocol into a necessary data format, such as, for example, OData™ format. In an embodiment, business objects may be transmitted to device 10 in the OData™ format through a platform.

The backend data of the business objects may be separated into categories representing data categories or analytic categories. The business objects may be in a necessary data format, such as, for example, OData™ format. In an example embodiment, backend data that corresponds to specific data categories may be rendered to customized categories. Examples of customized data categories may include but is not restricted to, “Marketing”, “Sales”, “Finance”, “Activity”, “Product”, “Business Partner”, “HR”, etc. The retrieved data may be separated into any one of the customized categories. For example, if the backend data of a business object indicates that the business object may correspond to advertising information, the formatted data of the business object may be categorized in the “Marketing” category. In another example, if the backend data of a business object indicates that the business object corresponds to a specific product, the formatted data of the business object may be categorized in the “Product” category.

In another embodiment, backend data that provides specific analytic information about a business object may be rendered to a specific customized analytic categories. Examples of customized analytic categories may include data coming from various analytic sources that may correlate to, but is not restricted to, “Business Intelligence”, “HANA™”, and “Business Object™”. This metadata may provide information pertaining to the analytics of the business object, and the corresponding retrieved formatted data may be separated into one of the customized categories.

Classifying the backend data of the business objects to customized categories may allow for the dynamic creation of the calendar entries in the calendar application. In an embodiment, each business object may have different actions, behavior, data, or analytics assigned to them at runtime based on the categorization of the metadata.

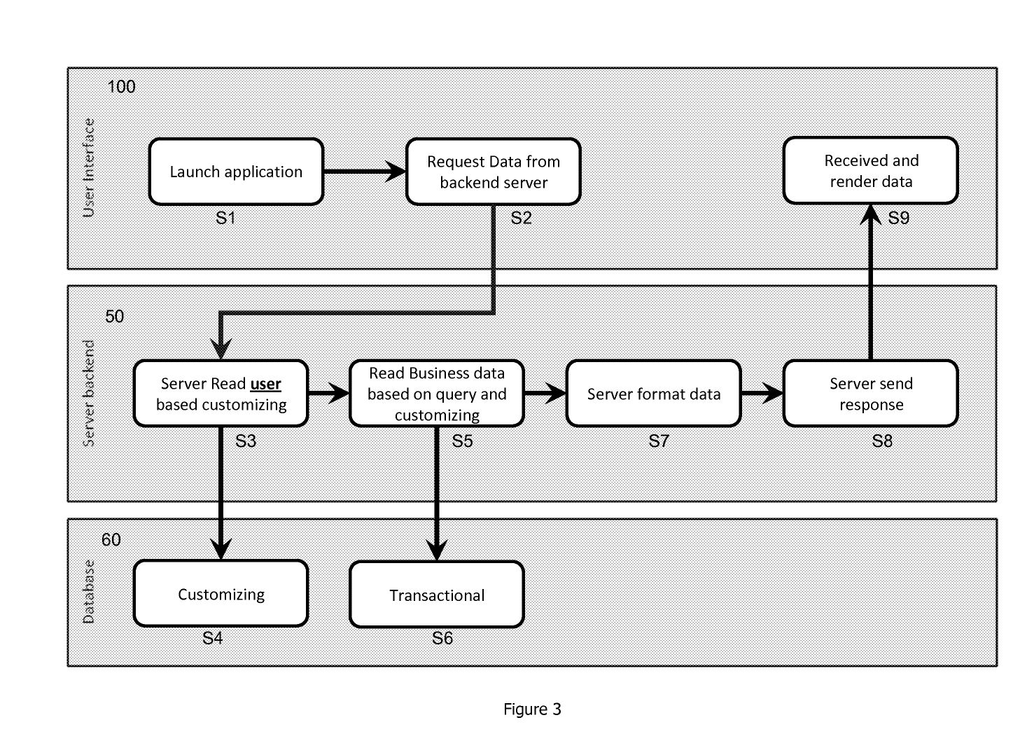

FIG. 3 illustrates a process for retrieving business objects from a backend server at runtime according to an embodiment. In an embodiment, both internal backend system 30 and external backend system 50 may be used as backend servers. In another embodiment, external backend system 50 may be the only backend server used, as illustrated in the process of FIG. 3. In step S1, a user may launch the mobile application on device 10. The mobile application may be displayed in a user interface 100 on the device 10. In step S2, the mobile application may request data from a backend server.

In step S3, external backend system 50 may read any performed user based customization of the stored business objects. Any further customization into categories may be formed in the database 60 of the external backend system 50 which may categorize the metadata of the stored business objects into the predefined categories in step S4. In step S5, the server may retrieve the business objects and corresponding business data based on the query by the mobile application and any customization. Step S6 may provide any transactional analysis of the retrieved business objects and data, if necessary. In step S7, external backend system 50 may format the business data including the business objects to a necessary data format for transmission, such as, for example, OData format, through a gateway. External backend system 50 may transmit a response through a platform to the mobile application in device 10 in step S8. In step S9, the mobile application may receive the transmitted data and render the data as data objects in the calendar application based on the customization of the objects in accordance with FIG. 2.

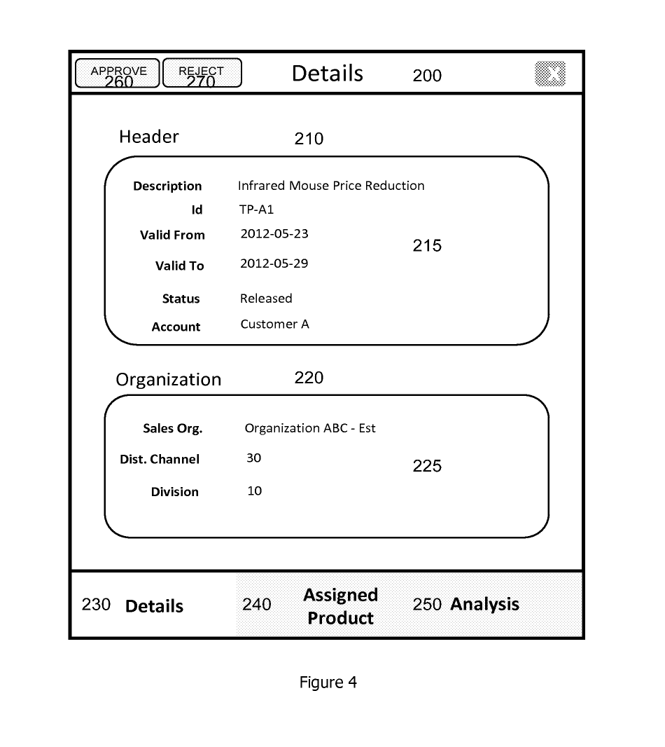

FIG. 4 illustrates the result of an executed custom action “display details” triggered by clicking/tapping a business object in the user interface. This resulting view, from the action execution, is rendered dynamically at runtime time based on the backend customization according to an embodiment.

Custom actions may include such actions as, but is not limited to, creating calendar entries, reading business objects, updating a business object, searching business objects, triggering a specific action or workflow, performing a search function, ungrouping business objects, etc. Each of these potential custom actions is assigned dynamically at runtime based on the backend customization of the metadata. In an embodiment, the result of an executed custom action, upon user interaction with the application or the device, may be the visualization of a modal view 200, which may provide additional custom actions may require further user interactions with the application or the device.

Window 200 may provide information corresponding to a specific business object in a “Details” section of window 200. In an embodiment, the result of the executed custom action may be presented in the “Details” section in window 200. In another embodiment, a user may navigate to the “Details” section by clicking on tab 230. Window 200 may include a first area 210 and a second area 220. In the “Details” section of window 200, the first area 210 may provide information about a business object, specifically the business object attribute values. In an embodiment where the business object is a business promotion, area 210 may provide information about the business promotion. Area 210 may include section field 215 which may provide specific information about the business object. In an embodiment where the business object is a business promotion, section field 215 may include, but is not limited to, section headers such as a description of the promotion, an identification number, a start date of the promotion, an end date of the promotion, a status of the promotion, and any corresponding customer account. All of the attributes and information in the sections of window 200 may be defined via customized categories in the backend and therefore rendered dynamically at runtime after the corresponding assigned custom action is triggered by the user.

In the “Details” section of window 200, the second area 220 may provide further information about a business object, specifically the business object attribute values corresponding to the internal sales organization. In an embodiment where the business object is a business promotion, area 220 may provide information about the business promotion. Area 220 may include section field 225 which may provide specific information about the business object. In an embodiment where the business object is a business promotion, section field 225 may include, but is not limited to, section headers such as a the internal sales organization performing the promotion, a distribution channel, and a sales division for the promotion. All of the attributes and information in area 220 and section field 225 may be defined via customized categories in the backend and therefore rendered dynamically at runtime after the corresponding assigned custom action is triggered by the user.

Window 200 may include tabs 240 and 250. Selection of tab 240 may provide a user with further information about a product associated with a specific business promotion. Selection of tab 250 may display related customized analytics to a specific business object. All of information in tabs 240 and 250 may be defined via customized categories in the backend and therefore rendered dynamically at runtime after the corresponding assigned custom action is triggered by the user.

In an embodiment, window 200 may also include buttons 260 and 270 which may represent, in this example embodiment, specific custom actions such as changing the status of a business promotion. The selection of buttons 260 or 270 may for example, allow for the changing of the status to approve or reject of the promotion, which corresponds to an attribute of the business object.

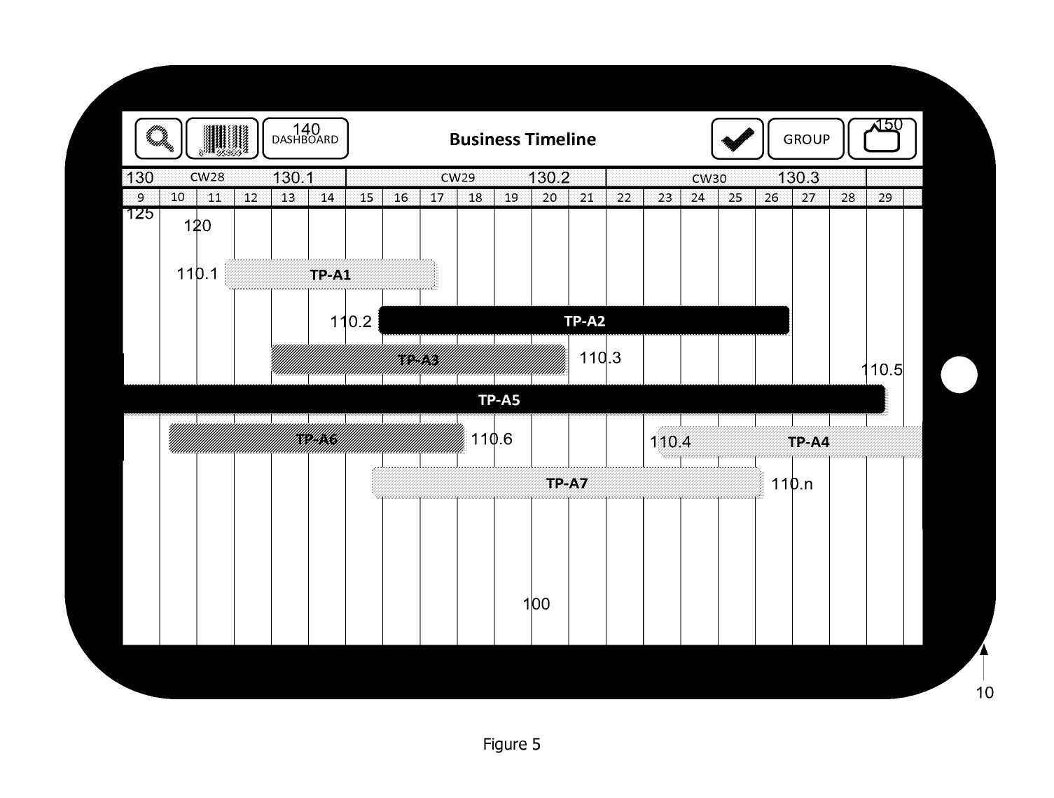

In the case in which a business object has been created for from the execution of a custom action, a visual representation of the business object may be dynamically created for display in the application. Visual representations associated with the business objects may be displayed on the user interface 100 of device 10 as visual bars. FIG. 5 illustrates a graphical user interface 100 that displays business objects dynamically rendered at runtime on device 10 according to an embodiment.

Each visual bar may present information about a dynamically rendered business object. In the example embodiment of FIG. 5, visual bars 110.1-110.n may be displayed on user interface 100. The number of visual bars may correspond to the number of business objects, as each visual bar may map to a specific business object of the business enterprise software. The visual bars may be rendered during runtime.

The information in visual bars 110.1-110.n may represent business objects of the business enterprise software. The business objects being displayed in visual bars 110.1-110.n may represent a modeling of a particular business process. In an example embodiment, the visual bars 110.1-110.n may correspond to information related to products, business promotions, sales orders, sales quotes, customer quotes, service documents, business opportunities, etc. Each of the business objects represented by a corresponding visual bar may include attributes that have been assigned via the metadata customized categories in the backend in FIG. 2. Attributes may include, for example, a specified time period, a specified product, customer information, product information, etc. In an example embodiment where the business object corresponds to a business promotion, attributes of the business object may include the promotion period of the promotion, including a start and end date, the companies offering the promotion and the companies being offered the promotion, and the product for which the promotion applies, including information pertaining to the product.

The attributes of business objects displayed user interface 100 may indicate a range of values. For example, in an embodiment where the business objects correspond to business promotions, each of the business objects in visual bars 110.1-110.n may include one or more attributes indicating the time period of the business promotion. The time period may be implemented by either defining a single time period attribute associated with the business object or by defining a start date attribute and an end date attribute associated with the business object.

The size of the visual bars 110.1-110.n in user interface 100 may be increased or decreased relative based on a selection by a user of the displayed time interval scales of the calendar application. In an embodiment, multiple displayed time interval ranges 125 and 130.1-130.2 may be displayed in user interface 100. The displayed time intervals may represent a range of values associated with at least one business object attribute. The visual bars may be positioned in the calendar application relative to the size of the displayed time intervals of the horizontal axis. In an embodiment, a first selection for a time interval scale may be made for displayed range 125. In the example embodiment in FIG. 5, range 125 may be selected to correspond to a daily time period. In this embodiment, the entries in time range 125 may correspond to subsequent days in the overall business timeline of the application. In alternate embodiments, the time interval scale for range 125 may be selected to, but is not limited to, correspond to a weekly, monthly, bi-monthly, quarterly, bi-annually, or annual scale.

Similarly, a selection may be made for the time interval scale for displayed range 130. In the example embodiment in FIG. 5, range 130 may be selected to correspond to a weekly time period. In this embodiment, the entries in time range 130 may correspond to subsequent weeks in the overall business timeline of the application. Each entry 130.1-130.3 in range 130 may map to a subset of range 125. For example, in the example embodiment of FIG. 5, days 15 to 21 in range 125 may correspond to calendar week 29 of entry 130.2. In alternate embodiments, the time interval scale for range 130 may be selected to, but is not limited to, correspond to a monthly, bi-monthly, quarterly, bi-annually, annual, or period of multiple years.

The size of visual bars 110.1-110.n may change dependent on the selection of the time interval scales for ranges 125 and 130. In an embodiment where range 125 is selected to correspond to a daily time period, visual bars 110.1-110.n may increase in size. In an embodiment where range 125 is selected to correspond to a weekly, monthly, bi-monthly, quarterly, bi-annually, or annual scale, the size of visual bars 110.1-110.n may decrease. The size of visual bars 110.1-110.n may decrease as larger time periods are selected.

The visual bars 110.1-110.n visualized in the user interface may be positioned relative to the displayed time intervals. The business objects associated with each visual representation and specific detail box may include business object attribute values in common with other business objects that are also visualized in the user interface 100. User interface 100 may include a button 140 which may allow for the display of the customized analytics of a business object in a generated dashboard chart (not shown). The dashboard chart may provide an analytic snapshot view of one or more business objects in the application. In an embodiment, the dashboard chart may be automatically adjusted based on calendar entry related content.

User interface 100 may also include button 150 which upon selection, may allow for detail boxes 117.1-117.n to be displayed or hidden in the user interface 100. Detail boxes 117.1-117.n may include information about the corresponding business object.

In an alternate embodiment, the business objects represented by visual bars 110.1-110.n may be edited by selected the corresponding visual bar. This may be accomplished in a device 10 with a touch screen by touching the corresponding visual bar, or in other devices, through clicking using a mouse, trackball, keypad, keyboard, etc.

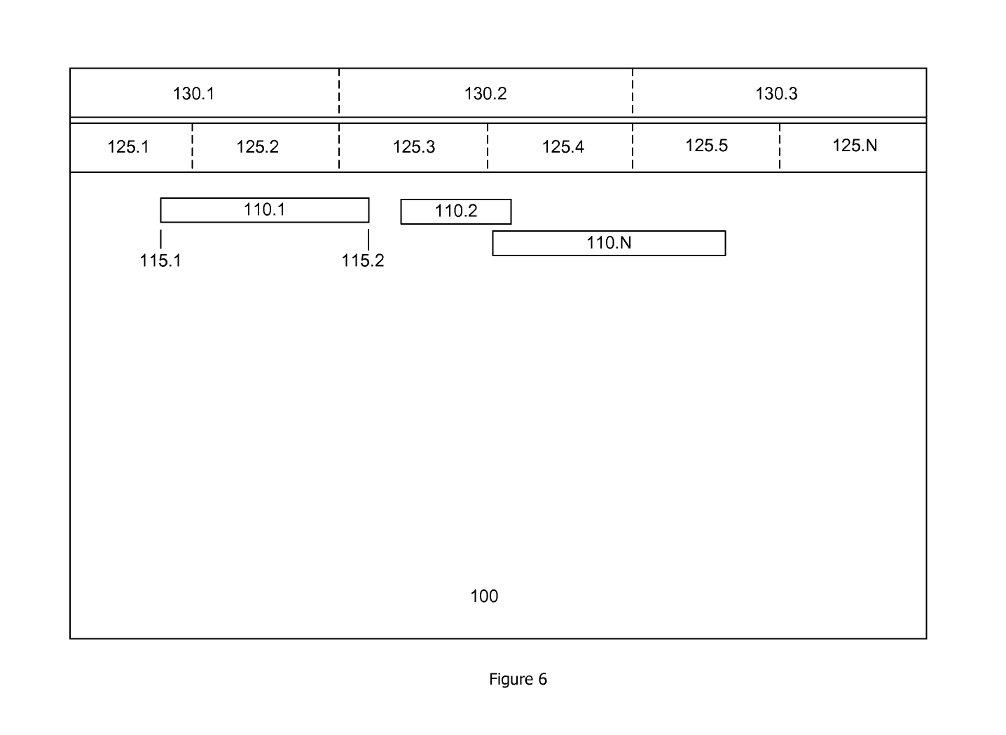

FIG. 6 further illustrates the layout of the user interface 100 displaying business objects dynamically rendered at runtime on device 10 according to an embodiment. In an embodiment, the business objects may be displayed on user interface 100 in an organized manner to visually convey information about the business objects. The business objects may be displayed in visual bars 110.1-110.n on the user interface 100 based on the triggered custom actions.

Visual bars 110.1-110.n may be visually displayed on the user interface 100 based on the selection of the display time intervals scales for ranges 125 and 130. In an example embodiment, displayed time ranges 125 and 130 may represent time periods. Displayed time range 125 may be divided into units 125.1-125.n that may correspond to a specified time period, such as, for example, a daily time period. In other embodiments, time range 125 may be divided into time periods based on a monthly, quarterly, or annual basis. Displayed time range 130 may be divided into units 130.1, 130.2, and 130.3, as in the example embodiment of FIG. 6, that may correspond to a specified time period. The time period for range 130 may correspond to a range that is bigger than the selected time period for range 125. For example, if range 125 is divided into daily time periods, range 130 may be selected to correspond to monthly time periods. In an alternate embodiment where the selected time intervals for range 130 has been selected to be calendar years, the intervals for range 125 may be selected, for example, to correspond to business quarters.

In the example embodiment in FIG. 6, range 125 may be displayed in the user interface 100 above the visual bars. Range 130 may be displayed directly above range 125 in the user interface 100.

In an embodiment, the visual bars 110.1-110.n displayed on the user interface 100 may be positioned and presented based on respective attribute values of the business objects relative to the selected time interval scales of ranges 125 and 130. Each visual bar 110.1-110.n may include attributes indicating, for example, the business promotion period of the respective business promotion business object. The visual bars 110.1-110.n may be presented to visually convey the span of the business promotion periods, and the start/end of the business promotion periods. Each of the visual bars 110.1-110.n may include a start date 115.1 and an end date 115.2 where the visual bar begins and ends in the user interface 100. In an example embodiment where the business objects correspond to a business promotion, start date 115.1 may correspond to the start of a promotion or buying period, etc. Conversely, end date 115.2 may correspond to the end of a promotion or buying period, etc.

The size of the visual bars 110.1-110.n as displayed in user interface 100 may depend on the selected time intervals in ranges 125 and 130. As the time intervals scales of the ranges 125 and 130 are selectively increased or decreased by a user, the size of the visual bars may change based on the selection.

User interface 100 may also display visual bars that correspond to other time periods in ranges 125 and 130. For example, user interface 100 may display business promotions in a current year, with the visual representation displayed in interface 100 determined by selection of ranges 125 and 130. A user may however, desire to view previous promotions in a previous year, for example, or future promotions is a subsequent year. In an example embodiment, a user may scroll to a previous time period to view previous promotions by scrolling to the left using his or her finger where device 10 has a touch screen, or a mouse, a keyboard, a keypad, a trackball, etc., for other devices. The displayed time interval units 125.1-125.n may display new time periods corresponding to the previously selected year, incremented by the selected time interval scale for range 125. Displayed time interval units 130.1-130.3 may also display new time periods corresponding to the previously selected year, incremented by the selected time interval scale for range 130.

In an alternate embodiment, a user may scroll to a future time period to view any planned future business promotions. The user may scroll to the right by using his or her finger where device 10 has a touch screen, or a mouse, a keyboard, a keypad, a trackball, etc., for other devices. The displayed time interval units 125.1-125.n may display new time periods corresponding to the future time period, incremented by the navigated time interval scale for range 125. Displayed time interval units 130.1-130.3 may also display new time periods corresponding to the future time period, incremented by the navigated time interval scale for range 130.

In an alternate embodiment, the business objects represented by visual bars 110.1-110.n may be edited by selected the corresponding visual bar. This may be accomplished in a device 10 with a touch screen by touching the corresponding visual bar, or in other devices, by a mouse, trackball, keypad, keyboard, etc.

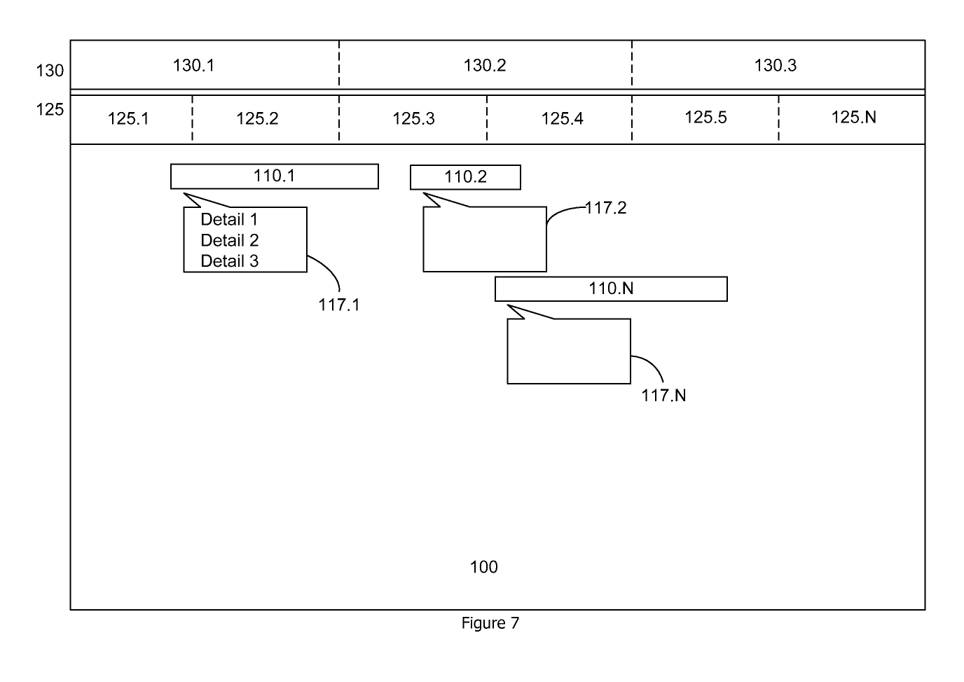

FIG. 7 illustrates the user interface 100 displaying business objects alongside detail boxes containing business object information dynamically rendered at runtime on device 10 according to an embodiment. In an embodiment, the business objects may be displayed on user interface 100 in an organized manner to visually convey information about the business objects. The business objects may be displayed in visual bars 110.1-110.n on the user interface 100. After the performance of a dynamic custom action, like clicking/tapping a visual bar 110.1-110.n, a detail view of the business object may be displayed in accordance with the embodiment in FIG. 4.

Visual bars 110.1-110.n may be visually displayed on the user interface 100 based on the selection of the display time intervals scales for ranges 125 and 130 which may be divided into units 125.1-125.n and 130.1-130.3 that correspond to a specified time period. As in the example embodiment in FIG. 6, visual bars 110.1-110.n displayed on the user interface 100 may be positioned and presented based on respective attribute values of the business objects relative to the selected time interval scales of ranges 125 and 130, with the size of the visual bars dependent on the selected time intervals.

Each visual bar 110.1-110.n may include attributes indicating, for example, the business promotion period of the respective business promotion business object. Details about the business object may be displayed in detail boxes 117.1-117.n. In the example embodiment of FIG. 7, detail box 117.1 may correspond to information about the business object in visual bar 110.1. This information may include or correspond to business object attributes, related images, graphics, charts, media, videos, etc. Similarly, detail box 117.2 may correspond to information about the business object attributes in visual bar 110.2, and detail box 117.n may correspond to information about the business object attributes in visual bar 110.n. In an embodiment, the number of detail boxes displayed in user interface 100 may be equal to the number of visual bars displayed in user interface 100. The number of detail boxes may also correspond to the number of business objects.

In an embodiment, the detail boxes 117.1-117.n may be displayed in the user interface 100 only after an action has been performed on a specific visual bar 110.1-110.n. An action performed may include, for example, clicking on button 150 with a mouse, trackball, keypad, or keyboard, etc., or touching a visual bar 110.1-110.n in a device 10 which has a touch screen. In an alternate embodiment, each detail box 117.1-117.n may only be displayed after the corresponding visual bar is displayed. In this alternate embodiment, detail box 117.1 may only be displayed if a user selects visual bar 110.1. Similarly, detail box 117.2 may only be displayed if a user selects visual bar 110.2. All remaining detail boxes, including 117.n, may only be displayed, if the remaining visual bars, including 110.n, are individually selected.

In an alternate embodiment, detail boxes 117.1-117.n may be displayed even if no actions were performed on the respective visual bars. In this alternate embodiment, all detail boxes 117.1-117.n may be displayed without the need for a user to perform any actions on visual bars 110.1-110.n by clicking or selecting the respective visual bar. The settings of the application may be configured to enable the display of the detail boxes respectively concurrently with the visual bars without the need to individually select the visual bars. The application may also be configured to disable the display of the detail boxes. In an embodiment where the detail boxes 117.1-117.n are displayed concurrently with visual bars 110.1-110.n, disabling the display of the detail boxes may remove the detail boxes 117.1-117.n from the user interface 100. The detail boxes 117.1-117.n may also be removed by the selection of button 150.

A user may selectively scroll through the application to view the visual bars and corresponding detail boxes for past and future time periods. This may accomplished by scrolling left or right with a user's finger on a touch screen, or scrolling left or right on a mouse, trackball, keypad, keyboard, etc. In an example embodiment, a user may scroll to a previous time period to view previous promotions by scrolling to the left using his or her finger where device 10 has a touch screen, or a mouse, keyboard, keypad, trackball, etc., for other devices. The displayed time interval units 125.1-125.n may display new time periods corresponding to the previously selected year, incremented by the selected time interval scale for range 125. Displayed time interval units 130.1-130.3 may also display new time periods corresponding to the previously selected year, incremented by the selected time interval scale for range 130. User interface 100 may display the corresponding visual bars and detail boxes for promotions that occurred in a selectively viewed previous time period.

A user may also selectively scroll through the application to view future time periods. The user may scroll to the right by using his or her finger where device 10 has a touch screen, or a mouse, keyboard, keypad, trackball, etc., for other devices. The displayed time interval units 125.1-125.n may display new time periods corresponding to the future selected time period, incremented by the selected time interval scale for range 125. Displayed time interval units 130.1-130.3 may also display new time periods corresponding to the future selected time period, incremented by the selected time interval scale for range 130. User interface 100 may display the corresponding visual bars and detail boxes for promotions that occurred in a selectively viewed future time period.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for visualizing business objects stored in a backend system in an application, the method comprising:
retrieving the business objects stored in the backend system;
classifying data of the business objects into customized categories;
during runtime, dynamically generating custom actions to be performed to each of the business objects based on customization of the data of the business objects;
performing the custom actions based on an interaction by a user; and
displaying visual representations of the business objects with their associated custom actions in a user interface.

2. The method according to claim 1, wherein the application is at least one of a calendar application, a timeline, and a multiple time dimension application.

3. The method according to claim 1, further comprising:
integrating the business objects with analytics corresponding to the business objects.

4. The method according to claim 1, further comprising:
transmitting the business objects to the application through a platform.

5. The method according to claim 1, further comprising:
converting the business objects into a necessary data format for transmission by a gateway.

6. The method according to claim 2, wherein the business objects can be edited in real-time within a calendar view of the calendar application.

7. The method according to claim 2, wherein business object attribute values can be edited in real-time within a calendar view of the calendar application.

8. The method according to claim 2, wherein the calendar application dynamically adapts to each rendered business object.

9. The method according to claim 3, further comprising:
displaying the analytics of the business objects in the user interface.

10. A device having an application stored thereon to visualize business objects stored in a backend system in the application, the device comprising:
an arrangement performing the following:
retrieving the business objects stored in the backend system;
classifying data of the business objects into customized categories;
during runtime, dynamically generating custom actions to be performed to each of the business objects based on customization of the data of the business objects;
performing the custom actions based on an interaction by a user; and
displaying visual representations of the business objects based on an execution of the custom actions in a user interface.

11. The device according to claim 10, wherein the application is at least one of a calendar application, a timeline, and a multiple time dimension application.

12. The device according to claim 10, wherein the arrangement integrates the business objects with analytics corresponding to the business objects, converts the business objects into a necessary data format for transmission by a gateway, and transmits the business objects to the application through a platform.

13. The device according to claim 11, wherein the business objects can be edited in real-time within a calendar view of the calendar application.

14. The device according to claim 11, wherein business object attribute values can be edited in real-time within a calendar view of the calendar application.

15. The method according to claim 11, wherein the calendar application dynamically adapts to each rendered business object.

16. The method according to claim 12, wherein the analytics of the business objects are displayed on the user interface.

17. An apparatus for visualizing business objects stored in a backend system in an application, the apparatus comprising:
a mobile device; and
a calendar application displayed on a user interface of the mobile device, the calendar application being executed to:
retrieve the business objects stored in the backend system;
classify data of the business objects into customized categories;
integrate the business objects with analytics corresponding to the business objects;
convert the business objects into a necessary data format for transmission by a gateway;
retrieve the business objects through a platform;
during runtime, dynamically generate custom actions to be performed to each of the business objects based on customization of the data of the business objects;
perform the custom actions based on an interaction by a user; and
display visual representations and analytics of the business objects based on an execution of the custom actions in a user interface.

18. A system for visualizing business objects stored in a backend system, the system comprising:
at least one backend server storing business objects;
a computer system running software to communicate to a mobile device;
the mobile device executing an application for display on an interface of the mobile device, the application executed to:
classify data of the business objects into customized categories;
retrieve the business objects from the at least one backend server;
convert the business objects into a necessary data format for transmission by a gateway;
during runtime, dynamically generate and assign custom actions to be performed to each of the business objects based on backend customization of the business objects;
perform the custom actions based on an interaction by a user; and
display visual representations and analytics of the business objects based on an execution of the custom actions in interface of the mobile device.
